(19) United States
(12) Patent Application Publication
(10) Pub. No.: US 2019/0134789 A1
(43) Pub. Date: May 9, 2019

(54) RATCHET WRENCH

(71) Applicant: Wei-Shan LIN, Taichung City (TW)

(72) Inventor: Wei-Shan LIN, Taichung City (TW)

(21) Appl. No.: 15/806,060

(22) Filed: Nov. 7, 2017

(51) Int. Cl. B25B 13/46; B25B 23/00

(52) U.S. Cl. CPC B25B 13/463; B25B 23/0007

(57) ABSTRACT

A ratchet wrench is provided, a toggle button thereof includes a toggling portion and a controlling portion, the toggle button is rotatably inserted in the a main body of the ratchet wrench via the controlling portion, the toggling portion is located outside the main body, the toggling portion is for being toggled to make the controlling portion rotate, a bottom portion of the controlling portion forms two positioning recesses, a top face of the controlling portion extends toward the toothed block to form a position-restricting portion, the position-restricting portion is located on an end of the controlling portion which is remote from the toggling portion so that the toothed block is sandwiched between an inner wall of the main body and the position-restricting portion and is hard to disengage.

### BACKGROUND OF THE INVENTION

### Field of the Invention

The present invention relates to a ratchet wrench.

### Description of the Prior Art

In a conventional ratchet wrench, a toggle button is firstly arranged in a wrench main body from one of two sides of the wrench main body and then positioned from the other of the two sides of the wrench main body with a positioning component to make the toggle button unable to detach from the wrench main body. The assembling process of the toggle button is inconvenient and requires many types of components. In addition, a toggling member is disposed on a front end of the toggle button form toggling a toothed block, when the toggling member is toggled, the toggling member hit an inner wall of the wrench main body directly, and after being used for a long time, the toggling member may be abraded. Besides, a length of the toggling member is limited by the toothed block and cannot be too long, so the toggling member gets stuck in a receiving chamber where the toggle button located more easily and may malfunction.

In TW587509, a bottom face of the receiving chamber where the toggle button located is closed, and a barrier chip is further provided to prevent the toggle button from dislocation. However, the toggling member still hits the inner wall of the wrench main body directly, so the problem of abrasion remains unsolved.

In TWM282787, the functions of the toggling member and the barrier chip are combined into the toggling member, and the toggling member has the same effect as the barrier chip; however, the toggling member still hits the inner wall of the wrench main body directly, so the problem of abrasion remains unsolved.

The present invention has arisen to mitigate and/or obviate the afore-described disadvantages.

### SUMMARY OF THE INVENTION

The major object of the present invention is to provide a ratchet wrench, which is easy to be manufactured and assembled, and a toggling member can be prevented from abrasion due to long-term usage.

To achieve the above and other objects, a ratchet wrench is provided, including a main body, a ratchet head, a toothed block, a toggle button, a toggling member, a first elastic member, a positioning member and a second elastic member.

The main body includes a working head and a grip, and the working head has a first receiving groove, a second receiving groove and a third receiving groove which are sequentially arranged and communicate with each other; the ratchet head is rotatably received within the first receiving groove, and the ratchet head includes an annular toothed surface and a working portion; the toothed block is received within the second receiving groove and movable between a first position and a second position, an end of the toothed block near the first receiving groove has a tooth rack, an end of the toothed block near the third receiving groove has a toggle groove, and the tooth rack is meshed with the annular toothed surface of the ratchet head; the toggle button includes a toggling portion and a controlling portion, the toggle button is rotatably inserted in the third receiving groove via the controlling portion, the toggling portion is located outside the main body, the toggling portion is for being toggled to make the controlling portion rotate, an end of the controlling portion remote from the toothed block forms two positioning recesses, a face of the controlling portion which faces the toothed block extends toward the toothed block to form a position-restricting portion, and the position-restricting portion is located on an end of the controlling portion which is remote from the toggling portion so that the toothed block is sandwiched between an inner wall of the second receiving groove and the position-restricting portion and is hard to disengage; the toggling member is connected to the controlling portion of the toggle button via the first elastic member, and an end of the toggling member opposite to the toggle button extends into the toggle groove of the toothed block; the positioning member is arranged in an end of the third receiving groove remote from the second receiving groove, the second elastic member makes the positioning member have a tendency to move toward the toggle button, and the positioning member optionally abuts against one of the two positioning recesses; the toggle button rotates to switch the toothed block to be on the first position or the second position via the toggling member.

The ratchet wrench provided in the present invention has a simple structure and is easy to be manufactured and assembled, and the ratchet wrench does not require additional components to function. In addition, the toggling member can function smoothly without being overly abraded and stuck.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of the present invention;

FIG. 2 is a breakdown perspective view of the present invention;

FIG. 3 is a cross-sectional view of the present invention; and

FIGS. 4 and 5 are drawings showing the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

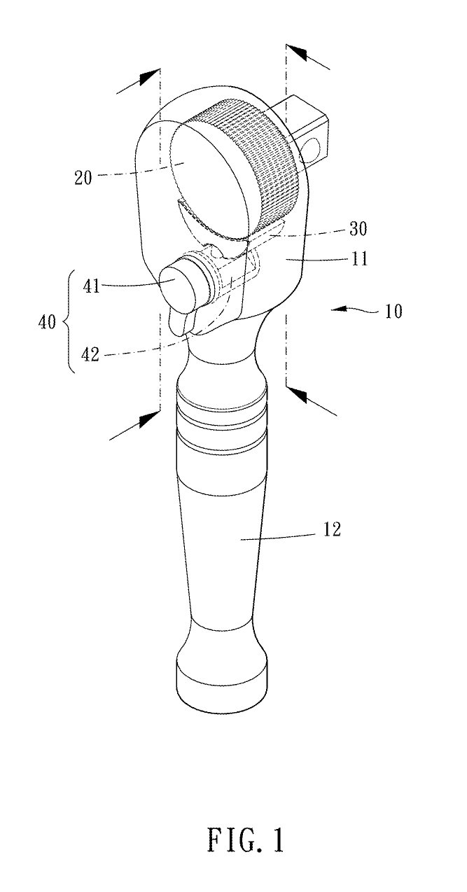

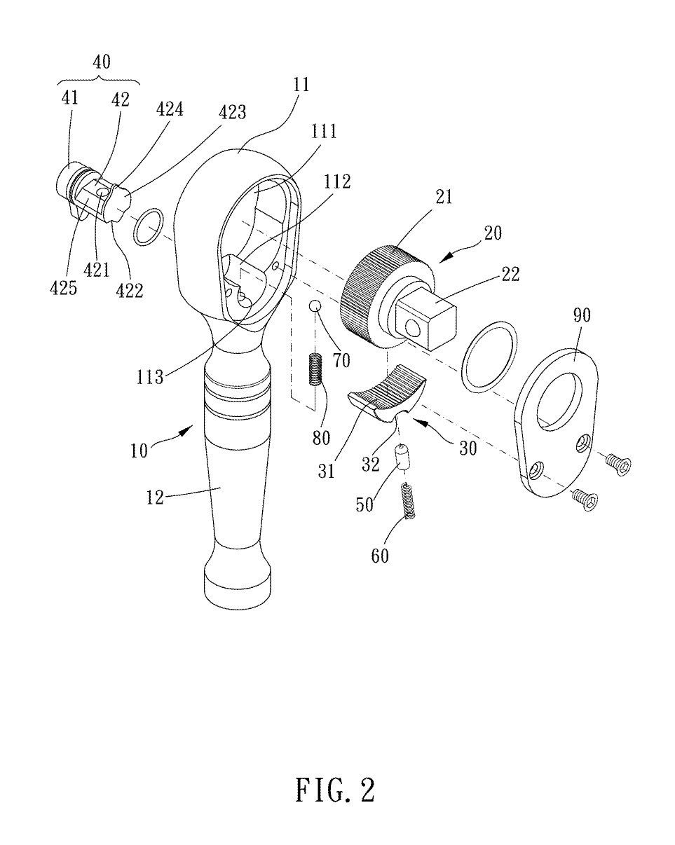

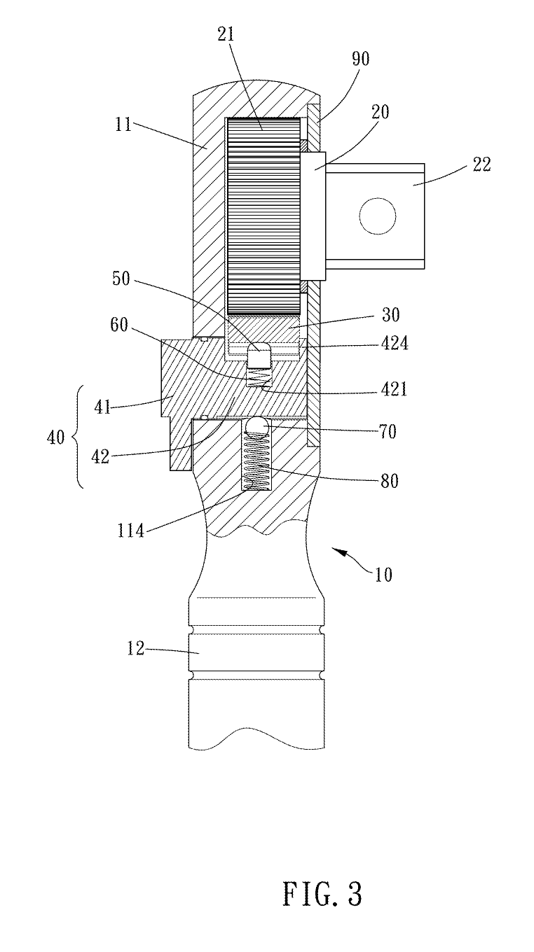

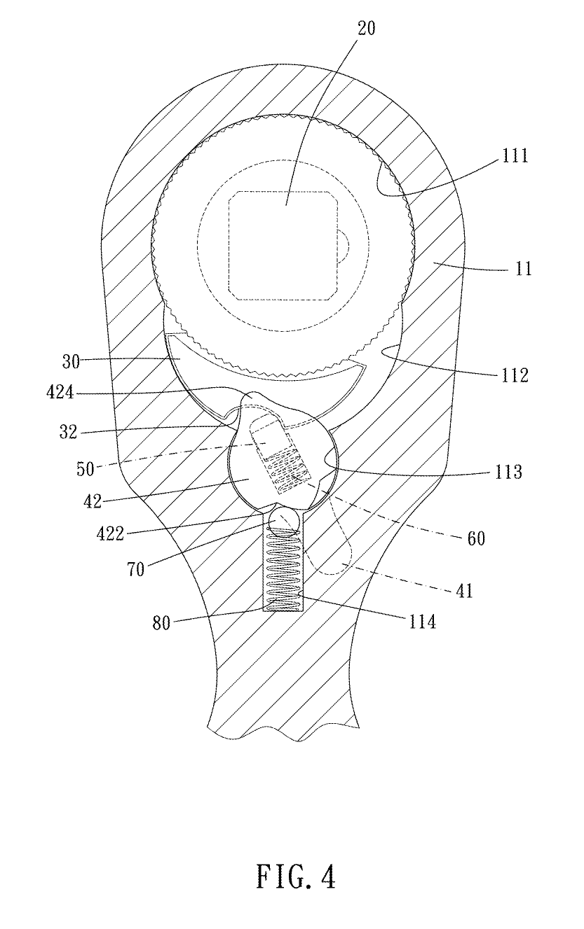

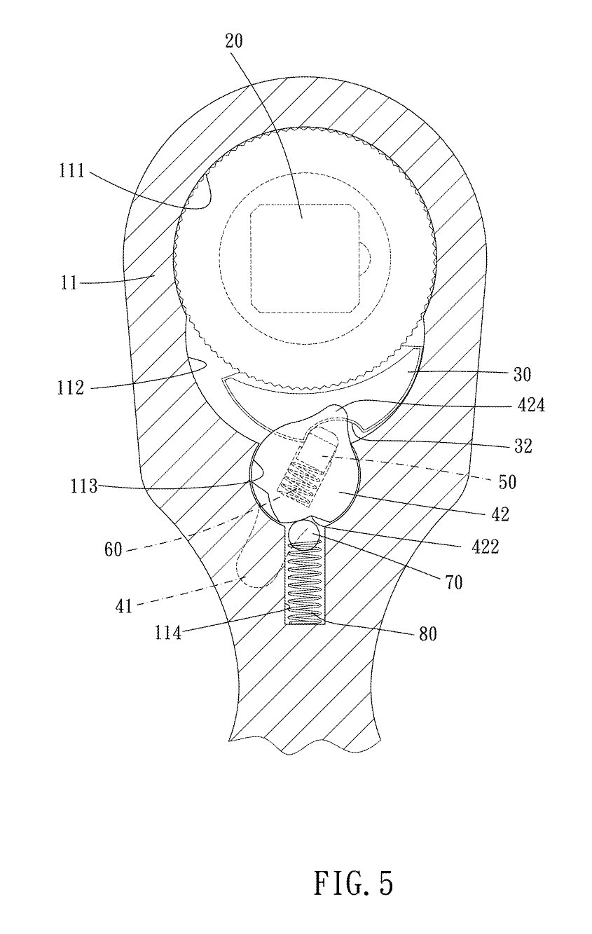

Please refer to FIGS. 1 to 5 for a ratchet wrench of the present invention, including a main body 10, a ratchet wrench 20, a toothed block 30, a toggle button 40, a toggling member 50, a first elastic member 60, a positioning member 70 and a second elastic member 80.

The main body 10 includes a working head 11 and a grip 12, and the working head 11 has a first receiving groove 111, a second receiving groove 112 and a third receiving groove 113 which are sequentially arranged and communicate with each other. More specifically, the working head 11 and the grip 12 are integrally formed, the first receiving groove 111, the second receiving groove 112 and the third receiving groove 113 are sequentially arranged toward the grip 12, the first receiving groove 111 is round, the second receiving groove 112 is crescent, the third receiving groove 113 is substantially round and partly overlaps with the second receiving groove 112, the first receiving groove 111 and the second receiving groove 112 have closed bottom faces and open top portions, and a bottom portion and a top portion of the third receiving groove 113 are open. In addition, a lateral side of an end of the third receiving groove 113 remote from the second receiving groove 112 (or the toothed block 30) further has a second receiving hole 114.

The ratchet head 20 is rotatably received within the first receiving groove 111, and the ratchet head 20 includes an annular toothed surface 21 and a working portion 22. More specifically, the ratchet head 20 is arranged into the first receiving groove 111 through the top potion of the first receiving groove 111, and the working portion 22 may be a polygonal column or a polygonal hole which are for being connected to other tools.

The toothed block 30 (preferably curved) is received within the second receiving groove 112 and movable between a first position and a second position, an end of the toothed block 30 near the first receiving groove 111 has a tooth rack 31, an end of the toothed block 30 near the third receiving groove 113 has a toggle groove 32, and the tooth rack 31 is meshed with the annular toothed surface 21 of the ratchet head 20.

The toggle button 40 includes a toggling portion 41 and a controlling portion 42, the toggle button 40 is rotatably inserted in the third receiving groove 113 via the controlling portion 42, the toggling portion 41 is located outside the main body 10, the toggling portion 41 is for being toggled to make the controlling portion 42 rotate, an end of the controlling portion 42 remote from the toothed block 30 forms two positioning recesses 422, a face of the controlling portion 42 which faces the toothed block 30 extends toward the toothed block 30 to form a position-restricting portion 424, the position-restricting portion 424 is located on an end of the controlling portion 42 which is remote from the toggling portion 41 so that the toothed block 30 is sandwiched between an inner wall of the second receiving groove 112 and the position-restricting portion 424 and is hard to disengage. In this embodiment, an end of the controlling portion 42 of the toggle button 40 facing the toothed block 30 has a top face, two sides of the top face respectively have an inclined face 425, the two inclined faces 425 respectively incline toward opposite sides of the top face, and preferably, an included angle between each of the two inclined faces 425 and the top face within the controlling portion 42 is 140 to 145 degrees. In addition, in this embodiment, an end of the controlling portion 42 of the toggle button 40 remote from the toggling portion 41 forms a barrier chip 423, the position-restricting portion 424 extends outward from a top end of the barrier chip 423, and an outer edge contour of an upper part of the barrier chip 423 is substantially round; that is, the barrier chip 423 and the toggling portion 41 have a recessed area therebetween, and the toothed block 30 is restricted within the recessed area.

The toggling member 50 is connected to the controlling portion 42 of the toggle button 40 via the first elastic member 60, and an end of the toggling member 50 opposite to the toggle button 40 extends into the toggle groove 32 of the toothed block 30. More specifically, an end of the toggle button 40 facing the toothed block 30 has a first receiving hole 421, and the first elastic member 60 and the toggling member 50 are received within the first receiving hole 421 so that the toggling member 50 has a tendency to move toward the toggle groove 32. The toggling member 50 is preferably a cylinder, and an outer diameter of a free end of the toggling member 50 tapers to form a chamfer.

The positioning member 70 is arranged in an end of the third receiving groove 113 remote from the second receiving groove 112, the second elastic member 80 makes the positioning member 70 have a tendency to move toward the toggle button 40, and the positioning member 70 optionally abuts against one of the two positioning recesses 422. More specifically, the second elastic member 80 and the positioning member 70 are received within the second receiving hole 114, and the positioning member 70 is preferably a ball.

The first receiving groove 111 and the second receiving groove 112 have bottom faces which are closed, the third receiving groove 113 is open, after the controlling portion 42 of the toggle button 40 is disposed from a bottom opening of the third receiving groove 113 into the third receiving groove 113, the toothed block 30 is arranged from a top opening of the first receiving groove 111 into the first receiving groove 111, slides to the second receiving groove 112 and is blocked by the position-restricting portion 424 and non-detachable (the toggle button 40 is also non-detachable due to the toothed block 30), then the ratchet head 20 is arranged from a top opening of the second receiving groove 112 into the second receiving groove 112, and a cover board 90 covers the top faces of the first receiving groove 111, the second receiving groove 112 and the third receiving groove 113 to close the first, second and third receiving grooves 111, 112, 113.

With the above-mentioned structure, the toggle button 40 rotates to switch the toothed block 30 to be on the first position or the second position via the toggling member 50.

Given the above, with the well-designed assembly sequence, the toggle button can be prevented from dislocation without additional components, the barrier chip can prevent the toggling member from falling into the receiving grooves, and the position-restricting portion hits an inner wall of the receiving grooves instead of the toggling member so as to prevent the toggling member from being overly abraded and from being struck. Most importantly, the toggle button can achieve multiple functions with single one component, so the present invention requires less elements and is easy and quick to be assembled.

While we have shown and described various embodiments in accordance with the present invention, it should be clear to those skilled in the art that further embodiments may be made without departing from the scope of the present invention.

What is claimed is:

1. A ratchet wrench, including:
a main body, including a working head and a grip, the working head having a first receiving groove, a second receiving groove and a third receiving groove which are sequentially arranged and communicate with each other;
a ratchet head, rotatably received within the first receiving groove, the ratchet head including an annular toothed surface and a working portion;
a toothed block, received within the second receiving groove and movable between a first position and a second position, an end of the toothed block near the first receiving groove having a tooth rack, an end of the toothed block near the third receiving groove having a toggle groove, the tooth rack being meshed with the annular toothed surface of the ratchet head;
a toggle button, including a toggling portion and a controlling portion, the toggle button being rotatably inserted in the third receiving groove via the controlling portion, the toggling portion being located outside the main body, the toggling portion for being toggled to make the controlling portion rotate, an end of the controlling portion remote from the toothed block forming two positioning recesses, a face of the controlling portion which faces the toothed block extending toward the toothed block to form a position-restricting portion, the position-restricting portion being located on an end of the controlling portion which is remote from the toggling portion so that the toothed block is sandwiched between an inner wall of the second receiving groove and the position-restricting portion and is hard to disengage;
a toggling member and a first elastic member, the toggling member connected to the controlling portion of the toggle button via the first elastic member, an end of the toggling member opposite to the toggle button extending into the toggle groove of the toothed block;
a positioning member and a second elastic member, the positioning member arranged in an end of the third receiving groove remote from the second receiving groove, the second elastic member making the positioning member have a tendency to move toward the toggle button, the positioning member optionally abutting against one of the two positioning recesses;
wherein the toggle button rotates to switch the toothed block to be on the first position or the second position via the toggling member.

2. The ratchet wrench of claim 1, wherein an end of the controlling portion of the toggle button facing the toothed block has a top face, two sides of the top face respectively have an inclined face, and the two inclined faces respectively incline toward opposite sides of the top face.

3. The ratchet wrench of claim 2, wherein an included angle between each of the two inclined faces and the top face within the controlling portion is 140 to 145 degrees.

4. The ratchet wrench of claim 1, wherein an end of the toggle button facing the toothed block has a first receiving hole, and the first elastic member and the toggling member are received within the first receiving hole.

5. The ratchet wrench of claim 1, wherein a lateral side of an end of the third receiving groove remote from the second receiving groove has a second receiving hole, and the second elastic member and the positioning member are received within the second receiving hole.

6. The ratchet wrench of claim 1, wherein the first receiving groove and the second receiving groove have bottom faces which are closed, the third receiving groove is open, after the controlling portion of the toggle button is disposed from a bottom opening of the third receiving groove into the third receiving groove, the toothed block is arranged from a top opening of the first receiving groove into the first receiving groove, slides to the second receiving groove and is blocked by the position-restricting portion and non-detachable, then the ratchet head is arranged from a top opening of the second receiving groove into the second receiving groove, and a cover board covers the top faces of the first receiving groove, the second receiving groove and the third receiving groove to close the first, second and third receiving grooves.

7. The ratchet wrench of claim 1, wherein the toothed block is curved.

8. The ratchet wrench of claim 1, wherein the toggling member is a cylinder.

9. The ratchet wrench of claim 1, wherein the positioning member is a ball.

10. The ratchet wrench of claim 1, wherein an end of the controlling portion of the toggle button remote from the toggling portion forms a barrier chip, the position-restricting portion extends outward from a top end of the barrier chip, and an outer edge contour of an upper part of the barrier chip is substantially round.
